(19) United States
(12) Patent Application Publication
(10) Pub. No.: US 2024/0020822 A1
(43) Pub. Date: Jan. 18, 2024

(54) TEACHER DATA PREPARATION METHOD AND PREPARATION DEVICE

(71) Applicant: HONDA MOTOR CO., LTD., Tokyo (JP)

(72) Inventors: Toshikazu KARUBE, Tokyo (JP); Kosuke JOJIMA, Tokyo (JP); Yutaka YOSHIDA, Saitama-ken (JP)

(21) Appl. No.: 18/350,091

(22) Filed: Jul. 11, 2023

(30) Foreign Application Priority Data
Jul. 12, 2022 (JP) 2022-111624

(51) Int. Cl. G06T 7/00; G06V 10/764

(52) U.S. Cl. CPC G06T 7/001; G06V 10/764; G06T 2207/30108; G06T 2207/20076; G06T 2207/20081

(57) ABSTRACT

A teacher data preparation method for preparing non-defective product teacher data and defective product teacher data, in a defect classification model that performs learning using a non-defective product image and a defective product image, the teacher data preparation method comprising:
acquiring, as the non-defective product teacher data, many pieces of non-defective product feature quantity data obtained by extracting a feature quantity in a predetermined first number of dimensions from a large number of the non-defective product images; and
acquiring, as the defective product teacher data, many pieces of generated defective product feature quantity data obtained by generating the feature quantity in the predetermined first number of dimensions, by using a generation model that has performed learning using defective product feature quantity data obtained by extracting the feature quantity in the predetermined first number of dimensions from the defective product images smaller in number than the non-defective product images.

### BACKGROUND

### Technical Field

The present invention relates to teacher data preparation method and preparation device, in a classification model to be applied to an inspection device or the like having a machine learning function that uses a neural network so as to determine quality of an inspected object.

### Related Art

In recent years, with an inspection device including a classification model that uses a neural network, progress has been made on the development of automation technology in inspection work for determining whether inspected objects such as various types of industrial products or components are each a normal product (non-defective product) or an abnormal product (defective product). In a classification model used in such an inspection device, learning is performed by reading, as teacher data, many pieces of image data of appearances of inspected objects that have been classified as the non-defective products and the defective products. Then, the classification model that has learned classification criteria becomes capable of classifying a new inspected object that has been imaged by a camera, as a non-defective product or a defective product.

In general, the determination accuracy of the classification model of such an inspection device depends on the quality and the amount of data to be learned. Conventionally, for example, as in JP 2021-144314 A, a technique for performing learning of a classification model using only non-defective product image data as teacher data has been proposed. It is easy to obtain the non-defective product image data, and it is easy to prepare a large number of images. However, on the other hand, in a case where only the non-defective product image data is used for learning, it is not possible to make differences between non-defective product images and defective product images learned. Hence, there is a problem that excessive detection of determining a non-defective product as a defective product increases in order to reduce an overlooking rate of the defective products.

In order to avoid such a problem, in the learning by the classification model, it is desirable to prepare many pieces of teacher data for both the non-defective products and the defective products and to perform the learning using them. However, in a manufacturing site of industrial products or the like, in general, the products are manufactured to produce defective products as few as possible. Hence, the number of defective products is usually very small relative to the number of non-defective products. For this reason, collection of the defective product image data has difficulties, as compared with the non-defective product image data that is relatively easily collectable.

To address such a problem, a technique for generating a large number of pseudo defective product images using a generation model that has performed learning using defective product images, and using them as teacher data for learning by the classification model has been proposed. For example, JP 2021-043816 A discloses a technique for mass-producing pseudo defective product images by a restoration device that has learned defective product images and defective product mask images that have been prepared by masking a defective area corresponding to a defect in the defective product image, and using the pseudo defective product images for the learning by the classification model.

### CITATION LIST

### Patent Literature

Patent Literature 1: JP 2021-144314 A
Patent Literature 2: JP 2021-043816 A

### SUMMARY

In a case where the pseudo defective product images are generated by the generation model as in JP 2021-043816 A, it is necessary to sufficiently perform the learning by the generation model in order to generate the pseudo defective product images with good quality. For this purpose, it is usually necessary to prepare many pieces of defective product image data to be training data. However, as described above, it is difficult to collect a large amount of defective product image data in the first place. In addition, regarding the pseudo defective product image that has been generated by the classification model that has performed learning with only a small amount of defective product image data, the quality as the teacher data for the learning by the classification model may be insufficient.

The present invention has been made to solve such a problem, and has an object to provide a teacher data preparation method capable of preparing teacher data with sufficient amount and quality, based on a large number of non-defective product images and a small number of defective product images.

In order to achieve such an object, according to a first aspect of the present invention, a teacher data preparation method for preparing non-defective product teacher data and defective product teacher data, in a defect classification model that performs learning using a non-defective product image that is an image of a product or a component with no defect and a defective product image that is an image of a product or a component with a defect, the teacher data preparation method including: a non-defective product teacher data acquiring step for acquiring, as the non-defective product teacher data, many pieces of non-defective product feature quantity data obtained by extracting a feature quantity in a predetermined first number of dimensions (p-dimension in an embodiment, hereinafter, the same will apply in the present paragraph) from a large number of the non-defective product images (step 302 in FIG. 3); and a defective product teacher data acquiring step for acquiring, as the defective product teacher data, many pieces of generated defective product feature quantity data obtained by generating the feature quantity in the predetermined first number of dimensions, by using a generation model (VAE, MLP decoder) that has performed learning using defective product feature quantity data obtained by extracting the feature quantity in the predetermined first number of dimensions from the defective product images smaller in number than the non-defective product images (step 303 in FIG. 3).

In such a teacher data preparation method, many pieces of non-defective product feature quantity data in a predetermined number of dimensions that have been extracted from a large number of non-defective product images are directly acquired as the non-defective product teacher data, whereas a few pieces of defective product feature quantity data in a predetermined number of dimensions that have been extracted from a small number of defective product images are used for the learning of the generation model, and many pieces of generated defective product feature quantity data in a predetermined number of dimensions are generated by the learned generation model, and are acquired as the defective product teacher data.

In this manner, the present invention has a characteristic of generating many pieces of generated defective product feature quantity data in the predetermined number of dimensions, based on the small number of defective product images, and are used as the defective product teacher data, without generating a large number of pseudo defective product images based on the small number of defective product images. It is sufficient if the generation model generates only the feature quantity data in the predetermined number of dimensions demanded as the teacher data, instead of the pseudo image. Therefore, the number of parameters to be processed by the generation model can be greatly reduced, as compared with a case where the pseudo defective product images are generated. Accordingly, the number of defective product images necessary for the learning of the generation model can be greatly reduced, and the generated defective product feature quantity data with sufficient quality can be generated, based on the small number of defective product images. Therefore, according to the present invention, it becomes possible to provide the teacher data preparation method capable of preparing teacher data with sufficient amount and quality, based on the large number of non-defective product images and the small number of defective product images.

According to a second aspect of the present invention, in the teacher data preparation method described in the first aspect, in which the defective product teacher data acquiring step includes: a first learning step for learning weighting of an encoder and a decoder to minimize a reconstruction error between an original image and a reconstructed image, in a variational auto encoder (VAE) including the encoder and the decoder, when the defective product image is input as the original image, the encoder reducing a dimension of the feature quantity that has been extracted from the original image and calculating a latent variable in a predetermined second number of dimensions (k-dimension) and a probability distribution of the latent variable, the decoder reconstructing the original image from the latent variable and the probability distribution and outputting the reconstructed image (step 401 in FIG. 4, steps 501 to 503 in FIG. 5); a correct answer data acquiring step for extracting the feature quantity in the predetermined first number of dimensions from the defective product image to acquire as learning correct answer data (step 601 in FIG. 6, FIG. 7); a feature quantity vector acquiring step for acquiring a feature quantity vector in the predetermined second number of dimensions corresponding to the defective product image from the probability distribution of the latent variable of the VAE that has performed the learning (step 602 in FIG. 6); a second learning step for learning weighting of a multilayer perceptron (MLP) decoder to minimize a loss between the generated defective product feature quantity data and the learning correct answer data, in the MLP decoder configured to generate and output the generated defective product feature quantity data in the predetermined first number of dimensions, when the feature quantity vector in the predetermined second number of dimensions that has been acquired is input (step 402 in FIG. 4, steps 603 to 605 in FIG. 6, FIG. 8); and a defective product feature quantity data generating step for inputting a large number of feature quantity vectors in the predetermined second number of dimensions that have been acquired by random sampling from the probability distribution of the latent variable of the VAE that has performed the learning into the MLP decoder that has performed the learning to generate many pieces of generated defective product feature quantity data (step 403 in FIG. 4, steps 901 to 903 in FIG. 9).

According to this configuration, in the first learning step, the variational auto encoder (hereinafter, referred to as VAE) is caused to perform learning so that a reconstructed image can be accurately output from the original defective product image. In addition, in the correct answer data acquiring step, the feature quantity in a predetermined number of dimensions is extracted from the defective product image, and is acquired as the learning correct answer data. In the feature quantity vector acquiring step, the feature quantity vector corresponding to the defective product image is acquired from the probability distribution of the latent variable of the learned VAE. Thereafter, in the second learning step, the multilayer perceptron decoder (hereinafter, referred to as an MLP decoder) is caused to perform learning so that the generated defective product feature quantity data that has been generated from the acquired feature quantity vector is similar to the learning correct answer data. By using the generation model including the VAE and the MLP decoder that have completed the preliminary learning in this manner, in the defective product feature quantity data generating step, a large number of feature quantity vectors are acquired by random sampling from the probability distribution of the latent variable of the learned VAE, and are input into the learned MLP decoder, and many pieces of generated defective product feature quantity data are generated.

For example, consideration is given to a case where the VAE is used as a generation model, a defective product image is input, and learning is performed to generate a pseudo defective product image. In this case, if the encoder compresses, for example, a defective product image of 256×256=65536 pixels into a latent variable in a lower dimension, for example, 500 dimensions, the decoder has to decode the latent variable in 500 dimensions into an image of 65536 pixels again, and the number of parameters processed by the decoder becomes enormous. On the other hand, in the present configuration, it is no longer necessary to generate the pseudo defective product image, and it is sufficient if only the feature quantity data in the predetermined number of dimensions demanded as the teacher data is generated. Therefore, for example, in a case where the demanded number of dimensions of the feature quantity is 1000 dimensions, it is enough to decode the feature quantity data in 1000 dimensions from the latent variable in 500 dimensions.

Accordingly, since the number of parameters to be processed by the generation model can be greatly reduced, the number of defective product images necessary for the learning of the generation model can be greatly reduced. Therefore, it is possible to generate the generated defective product feature quantity data with sufficient quality, based on a small number of defective product images. In this manner, according to the present configuration, it becomes possible to provide the teacher data preparation method capable of preparing teacher data with sufficient amount and quality, based on a large number of non-defective product images and a small number of defective product images.

According to a third aspect of the present invention, a teacher data preparation device 11 that prepares non-defective product teacher data and defective product teacher data, in a defect classification model that performs learning using a non-defective product image that is an image of a product or a component with no defect and a defective product image that is an image of a product or a component with a defect, the teacher data preparation device includes: a non-defective product teacher data acquisition unit 12 configured to acquire, as the non-defective product teacher data, many (M) pieces of non-defective product feature quantity data obtained by extracting a feature quantity in a predetermined first number of dimensions from a large number of the non-defective product images; and a defective product teacher data acquisition unit 13 configured to acquire, as the defective product teacher data, many pieces of generated defective product feature quantity data obtained by generating the feature quantity in the predetermined first number of dimensions, by using a generation model that has performed learning using defective product feature quantity data obtained by extracting the feature quantity in the predetermined first number of dimensions from the defective product images (N) smaller in number than the non-defective product images.

In such a teacher data preparation device, many pieces of non-defective product feature quantity data in a predetermined number of dimensions that have been extracted from a large number of non-defective product images are directly acquired as the non-defective product teacher data, whereas a few pieces of defective product feature quantity data in a predetermined number of dimensions that have been extracted from a small number of defective product images are used for the learning of the generation model, and many pieces of generated defective product feature quantity data in a predetermined number of dimensions are generated by the learned generation model, and are acquired as the defective product teacher data. In this manner, the present invention has a characteristic of generating many pieces of generated defective product feature quantity data in the predetermined number of dimensions, based on the small number of defective product images, and are used as the defective product teacher data, without generating a large number of pseudo defective product images based on a small number of defective product images. Therefore, the number of parameters to be processed by the generation model can be greatly reduced, as compared with a case where the pseudo defective product images are generated. Accordingly, the number of defective product images necessary for the learning of the generation model can be greatly reduced, and the generated defective product feature quantity data with sufficient quality can be generated, based on the small number of defective product images. Therefore, it becomes possible to provide the teacher data preparation device capable of preparing teacher data with sufficient amount and quality, based on a large number of non-defective product images and a small number of defective product images.

According to a fourth aspect of the present invention, in the teacher data preparation device described in the third aspect, in which the defective product teacher data acquisition unit 13 includes: a first learning unit (VAE preliminary learning unit 14) configured to learn weighting of an encoder and a decoder to minimize a reconstruction error between an original image and a reconstructed image, in a variational auto encoder (VAE) including the encoder and the decoder, when the defective product image is input as the original image, the encoder reducing a dimension of the feature quantity that has been extracted from the original image and calculating a latent variable in a predetermined second number of dimensions and a probability distribution of the latent variable, the decoder reconstructing the original image from the latent variable and the probability distribution and outputting the reconstructed image; a correct answer data acquisition unit 15 configured to extract the feature quantity in the predetermined first number of dimensions from the defective product image to acquire as learning correct answer data; a feature quantity vector acquisition unit 16 configured to acquire a feature quantity vector in the predetermined second number of dimensions corresponding to the defective product image from the probability distribution of the latent variable of the VAE that has performed the learning; a second learning unit (MLP preliminary learning unit 17) configured to learn weighting of a multilayer perceptron (MLP) decoder to minimize a loss between the generated defective product feature quantity data and the learning correct answer data, in the MLP decoder configured to generate and output the generated defective product feature quantity data in the predetermined first number of dimensions, when the feature quantity vector in the predetermined second number of dimensions that has been acquired is input; and a defective product feature quantity data generation unit 18 configured to input a large number of feature quantity vectors in the predetermined second number of dimensions that have been acquired by random sampling from the probability distribution of the latent variable of the VAE that has performed the learning into the MLP decoder that has performed the learning to generate many pieces of generated defective product feature quantity data.

According to this configuration, by using the generation model including the VAE and the MLP decoder that have completed the preliminary learning using the defective product images, in the defective product feature quantity data generation unit, a large number of feature quantity vectors are acquired by random sampling from the probability distribution of the latent variable of the learned VAE, and are input into the learned MLP decoder, and many pieces of generated defective product feature quantity data are generated. In the present configuration, the generation model including the VAE and the MLP decoder no longer has to generate the pseudo defective product image, and it is sufficient if it generates only the feature quantity data in the predetermined number of dimensions demanded as the teacher data. Therefore, the number of parameters to be processed by the generation model can be greatly reduced. Accordingly, since the number of defective product images necessary for the learning of the generation model can be greatly reduced, the generated defective product feature quantity data with sufficient quality can be generated, based on a small number of defective product images. In this manner, according to the present configuration, it becomes possible to provide the teacher data preparation device capable of preparing teacher data with sufficient amount and quality, based on a large number of non-defective product images and a small number of defective product images.

### BRIEF DESCRIPTION OF DRAWINGS

FIG. 1 is a diagram for describing an outline of an inspection system in which teacher data that has been prepared by a teacher data preparation device according to an embodiment of the present invention is used for learning;

FIG. 2 is a block diagram illustrating a teacher data preparation device according to an embodiment of the present invention;

FIG. 3 is a flowchart illustrating teacher data preparation processing by the teacher data preparation device;

FIG. 4 is a flowchart illustrating defective product teacher data acquisition processing by the teacher data preparation device;

FIG. 5 is a flowchart illustrating VAE learning processing by the teacher data preparation device;

FIG. 6 is a flowchart illustrating MLP learning processing by the teacher data preparation device;

FIG. 7 is a schematic diagram illustrating correct answer data acquisition processing by the teacher data preparation device;

FIG. 8 is a schematic diagram illustrating the MLP learning processing by the teacher data preparation device; and

FIG. 9 is a flowchart illustrating defective product feature quantity data generation processing by the teacher data preparation device.

### DETAILED DESCRIPTION

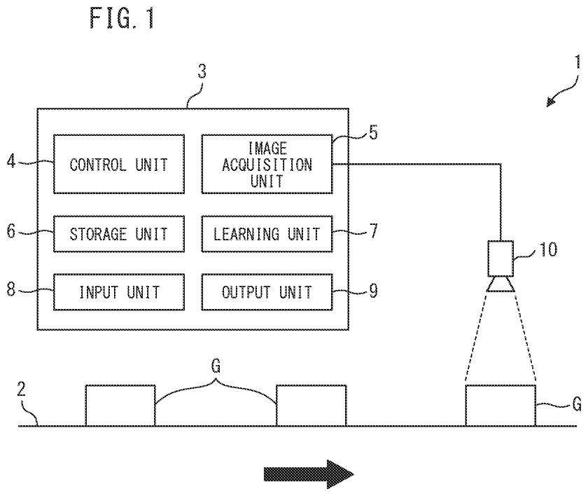

Hereinafter, preferred embodiments of the present invention will be described in detail with reference to the drawings. FIG. 1 illustrates an inspection system including a classification model that has performed learning using many pieces of non-defective product teacher data and many pieces of defective product teacher data that have been prepared by a teacher data preparation device 11 to be described later. The inspection system 1 is installed in, for example, a vehicle component manufacturing factory, and automatically determines whether a manufactured vehicle component (for example, a cylinder block) is a normal product (non-defective product) or an abnormal product (defective product) by inspecting the appearance of the vehicle component. Hereinafter, the vehicle component to be inspected will be referred to as an “inspected object”.

As illustrated in FIG. 1, the inspection system 1 includes a conveyor 2 for conveying an inspected object Gin a predetermined direction at a predetermined speed, and an inspection device 3 for determining the quality of the inspected object G, when the inspected object G reaches a predetermined inspection position. Note that the illustration is omitted, but the inspected object G that has been determined as a defective product by the inspection device 3 is removed from the conveyor 2, or is conveyed to a storage place dedicated to the defective products.

The inspection device 3 is configured with an information processing device mainly including a computer, and includes a control unit 4, an image acquisition unit 5, a storage unit 6, a learning unit 7, an input unit 8, an output unit 9, and a camera 10.

The control unit 4 includes a CPU, and controls the above respective units 5 to 9 and the camera 10 of the inspection device 3. The image acquisition unit 5 acquires, as digital data, an external appearance image of the inspected object G that has been imaged by the camera 10, and also extracts predetermined feature quantity data used for determining the quality of the inspected object G from the acquired image. The storage unit 6 includes a ROM and a RAM, stores various programs to be used in the control of the inspection device 3, and also stores various types of data. The learning unit 7 includes a learning model by which criteria for determining the quality of the inspected object G have been learned. The input unit 8 includes a keyboard and/or a mouse to be operated by an operator, and in addition, is configured so that data and/or signals can be input from the outside. The output unit 9 includes a display device such as a display on which a determination result of the inspected object G is displayed.

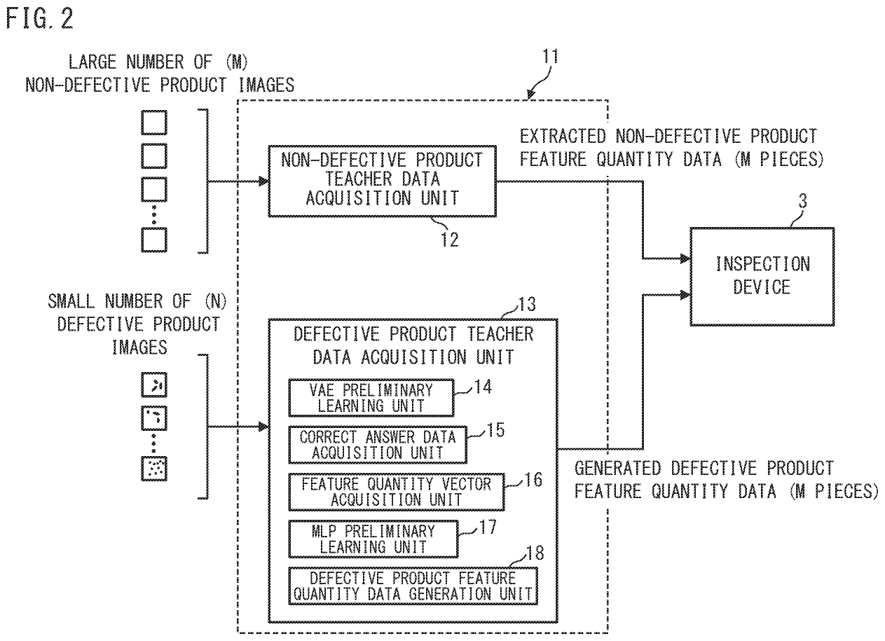

FIG. 2 illustrates a teacher data preparation device 11 according to an embodiment of the present invention. The teacher data preparation device 11 is operated by a worker who performs inspection work of the inspected object G to prepare teacher data of a non-defective product (non-defective product teacher data) and teacher data of a defective product (defective product teacher data) used for learning by the classification model in the learning unit 7 of the inspection device 3. Similarly to the inspection device 3 described above, the teacher data preparation device 11 is configured with an information processing device including a computer, and includes a non-defective product teacher data acquisition unit 12 and a defective product teacher data acquisition unit 13. In addition, the defective product teacher data acquisition unit 13 includes a VAE preliminary learning unit 14, a correct answer data acquisition unit 15, a feature quantity vector acquisition unit 16, an MLP preliminary learning unit 17, and a defective product feature quantity data generation unit 18. The teacher data preparation device 11 is connected with the inspection device 3 through a network, not illustrated.

The non-defective product teacher data acquisition unit 12 acquires a product that has been determined to be a non-defective product by the worker, as non-defective product image data, from among the external appearance images of the inspected objects G that have been imaged by a camera similar to the camera 10 of the inspection device 3 described above, from the external storage device, not illustrated, or the like.

For each of many (M) pieces of non-defective product image data that have been acquired, the non-defective product teacher data acquisition unit 12 extracts non-defective product feature quantity data in any p-dimension, by using a known algorithm for extracting a feature quantity from an image, such as, for example, scale-invariant feature transform (SIFT), histograms of oriented gradients (HOG), or convolutional neural network (CNN), and transmits the extracted data to the inspection device 3, as non-defective product teacher data.

The defective product teacher data acquisition unit 13 acquires an image of a product that has been determined to be a defective product by the worker, as defective product image data, from among the external appearance images of the inspected objects G that have been imaged by a camera similar to the camera 10 of the inspection device 3 described above, from the external storage device, not illustrated, or the like. Note that the defective product images to be acquired are desirably image data comprehensively including patterns of various defect shapes that can occur, by being selected by, for example, a skilled worker. In addition, the defective product images to be acquired may include not only an actual defective product image that has been selected by the worker but also pseudo defective product image data that has been generated by use of a generation model such as a variational auto encoder (VAE) or generative adversarial network (GAN).

As will be described later, the defective product teacher data acquisition unit 13 performs processing by using the above respective units 14 to 18 on a few (N) pieces of defective product image data that have been acquired, generates many (M) pieces of defective product feature quantity data in p-dimension that is the same with the above-described non-defective product feature quantity data, and transmits the data to the inspection device 3, as the defective product teacher data. The inspection device 3 performs learning of the classification model with the non-defective product teacher data and the defective product teacher data that have been received, as the teacher data.

Note that regarding the number of dimensions p of the non-defective product feature quantity data and the defective product feature quantity data, it is possible to set any number of dimensions that enables the classification model that has performed learning to exhibit high classification performance, and to set optionally in accordance with a design or the like of the classification model.

The VAE preliminary learning unit 14 includes a VAE as the generation model, and performs preliminary learning of the VAE by using the defective product image data that has been acquired, as training data. As the VAE in the present embodiment, a convolutional mixed normal distribution VAE capable of calculating a latent variable in any k-dimension having a feature of a defect and its probability distribution (latent probability distribution) from a few pieces of defective product image data that have been input is used. With this VAE, for input data x, it is possible to obtain a feature quantity vector Vk in k-dimension that has been compressed by a neural network, as a vector of a random variable taking a posterior probability distribution p(vk|x).

In the preliminary learning of the VAE, after the defective product image data that has been acquired is input as an original image, the dimension of the feature quantity that has been extracted from the original image is reduced and the latent variable in k-dimension and the latent probability distribution are prepared by an encoder of the VAE. Then, a reconstructed image, in which the original image is reconstructed from the latent variable in k-dimension and the latent probability distribution, is output by a decoder of the VAE. Then, learning of weighting of each parameter in the encoder and the decoder is performed so as to minimize an error (reconstruction error) between the original image and the reconstructed image (first learning step). When this preliminary learning is completed, the VAE becomes capable of outputting the reconstructed image approximate to the defective product image that has been input, and at the same time, a latent variable and a latent probability distribution that have been optimized for the reconstructed image are obtained.

For each piece of the defective product image data that has been acquired, the correct answer data acquisition unit 15 extracts a feature quantity in p-dimension, by using a known algorithm for extracting a feature quantity from an image, such as, for example, scale-invariant feature transform (SIFT), histograms of oriented gradients (HOG), or convolutional neural network (CNN), and acquires as learning correct answer data in p-dimension (learning correct answer data) to be used in MLP preliminary learning to be described later (correct answer data acquiring step).

The feature quantity vector acquisition unit 16 acquires feature quantity vectors in k-dimension Vk (v0, v1, v2, . . . vk−1) respectively corresponding to the defective product images that have been input, from the latent variable in k-dimension and the latent probability distribution that have been prepared in the VAE that has completed the preliminary learning (feature quantity vector acquiring step).

The MLP preliminary learning unit 17 includes a multilayer perceptron decoder (hereinafter, referred to as an MLP decoder), and performs preliminary learning of the MLP decoder using the learning correct answer data in p-dimension that has been acquired by the correct answer data acquisition unit 15, as the teacher data. When the feature quantity vector in k-dimension Vk that has been acquired by the feature quantity vector acquisition unit 16 is input, the MLP decoder is configured to output the feature quantity data in p-dimension (generated defective product feature quantity data) corresponding to the input. In the preliminary learning of the MLP decoder, the generated defective product feature quantity data in p-dimension that has been output is compared with learning correct answer data in p-dimension that has been acquired beforehand, and learning of weighting of each parameter of the MLP decoder is performed so as to minimize a loss between them (second learning step). When the preliminary learning is completed, the MLP decoder becomes capable of outputting generated defective product feature quantity data in p-dimension approximate to the learning correct answer data in p-dimension, in response to the input of the feature quantity vector Vk in k-dimension.

The defective product feature quantity data generation unit 18 acquires the feature quantity vector Vk in k-dimension from the latent variable and the latent probability distribution of the learned VAE by random sampling, and inputs it into the learned MLP decoder. In response to this input, the MLP decoder outputs the generated defective product feature quantity data in p-dimension corresponding to each feature quantity vector Vk in k-dimension (defective product feature quantity data generating step). The generated defective product feature quantity data in p-dimension that has been obtained in this manner is transmitted, as the defective product teacher data, to the inspection device 3, and is used for learning of the classification model.

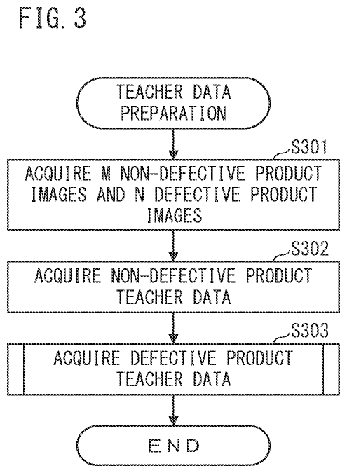

FIG. 3 illustrates preparation processing of the non-defective product teacher data and the defective product teacher data, by the teacher data preparation device 11 described above. In the present processing, first, in step 301 (indicated as “S301” in the drawing. The same applies, hereinafter), M pieces of non-defective product image data and N pieces of defective product image data are acquired from an external storage device or the like (not illustrated) connected with the teacher data preparation device 11 through a network. Here, M denotes a numerical number corresponding to the number of pieces of non-defective product teacher data or defective product teacher data necessitated for the classification model in the learning unit 7 of the inspection device 3 to perform sufficient learning, and may be, for example, about 2000. In general, since the majority of the inspected objects G manufactured in the manufacturing line are non-defective products, it is supposed that M pieces of non-defective product image data can be easily acquired. In addition, N denotes a numerical number significantly smaller than the above-described M. In addition, it is sufficient if N is a numerical number enough to perform processing of approximating the feature quantity that has been extracted from the acquired defective product image data to the normal distribution, and may be, for example, about 200.

Next, in step 302, any feature quantity data in p-dimension (non-defective product feature quantity data) is extracted from each of the acquired M pieces of non-defective product image data in a known method such as SIFT, HOG, or CNN, and is acquired as M pieces of non-defective product teacher data. Note that as described above, the number of dimensions p can be any number of dimensions suitable for the learning of the classification model that performs the learning using the teacher data. In the present embodiment, the number of dimensions p can be, for example, 1000, but is not limited to this.

Subsequently, in step 303, by using the generation model that has performed learning using N pieces of feature quantity data in p-dimension (defective product feature quantity data) that have been extracted from each of N pieces of defective product image data that have been acquired, M pieces of generated defective product feature quantity data in p-dimension are generated, and are acquired as the defective product teacher data. The defective product teacher data acquisition processing will be described in detail below.

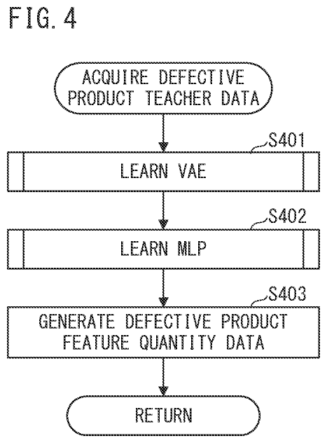

FIG. 4 illustrates details of the defective product teacher data acquisition processing. First, in step 401, preliminary learning of the VAE to be a part of the generation model in the present embodiment is performed.

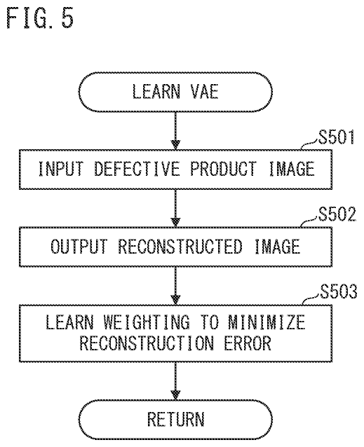

FIG. 5 illustrates details of VAE learning processing. First, in step 501, when acquired N pieces of defective product image data are input to the VAE, the encoder of the VAE compresses the feature quantity that has been extracted from the defective product images, and prepares the latent variable in k-dimension and the latent probability distribution. Note that the number of dimensions k can be set to any number of dimensions necessary for appropriately taking the features of the defective product images. In the present embodiment, the number of dimensions k is set to, for example, 500.

Next, in step 502, the decoder of the VAE outputs a reconstructed image obtained by reconstructing the defective product image that has been input from the latent variable in k-dimension and the latent probability distribution that have been prepared. Then, in subsequent step 503, learning of weighting of each parameter in the encoder and the decoder is performed so as to minimize a reconstruction error between the defective product image that has been input and the reconstructed image that has been output, and the present processing ends.

Returning to FIG. 4, after the preliminary learning by the VAE ends, the processing proceeds to step 402. In step 402, preliminary learning of the MLP decoder to be a part of the generation model in the present embodiment is performed.

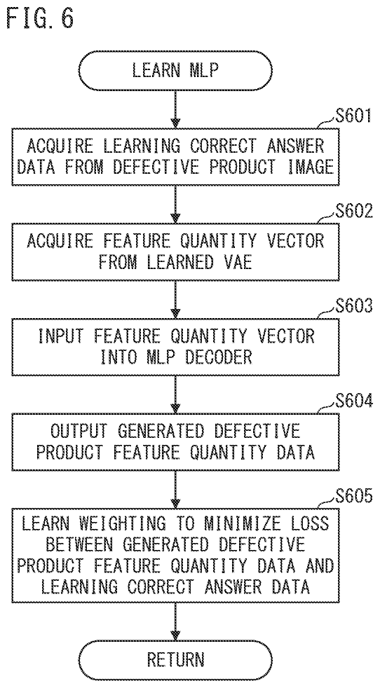

FIG. 6 illustrates details of the MLP decoder learning processing. First, in step 601, the learning correct answer data used in the present learning processing is acquired from the acquired N pieces of defective product image data.

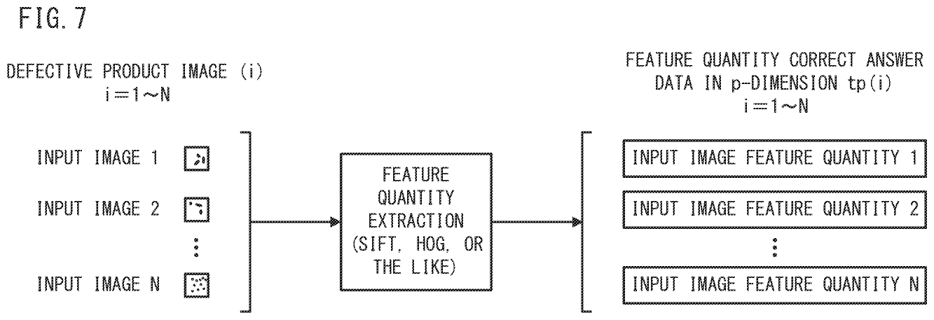

FIG. 7 is a schematic diagram illustrating the learning correct answer data acquisition processing in step 601. In the present processing, an algorithm for extracting a feature quantity from an image, such as SIFT, HOG, or CNN, is performed for each of N pieces of defective product image data (an input image 1 to an input image N). Accordingly, N pieces of feature quantity correct answer data in p-dimension (an input image feature quantity 1 to an input image feature quantity N) respectively corresponding to N pieces of defective product image data are acquired as the learning correct answer data.

In subsequent step 602, N feature quantity vectors in k-dimension Vk (v0, v1, v2, . . . vk−1) respectively corresponding to the acquired N pieces of defective product image data are acquired from the latent variable in k-dimension and the latent probability distribution that have been prepared in the learned VAE.

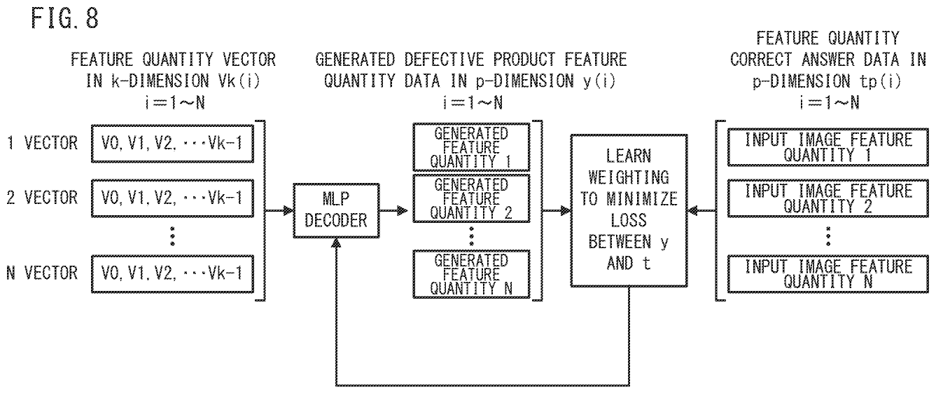

Subsequently, in the following steps 603 to 605, learning of the MLP decoder is performed by use of the learning correct answer data in p-dimension and the feature quantity vectors in k-dimension Vk acquired in steps 601 to 602. FIG. 8 is a schematic diagram illustrating the learning processing of the MLP decoder in steps 603 to 605.

First, in step 603, N feature quantity vectors in k-dimension Vk acquired in step 602 are input into the MLP decoder, and then in subsequent step 604, the MLP decoder decodes the feature quantity in p-dimension from each of N feature quantity vectors in k-dimension Vk, and outputs N pieces of generated defective product feature quantity data in p-dimension. Then, in next step 605, N pieces of generated defective product feature quantity data in p-dimension that have been output are compared with N pieces of feature quantity correct answer data in p-dimension (learning correct answer data) acquired in step 601, learning of weighting of each parameter by the MLP decoder is performed so as to minimize a loss between both data, and the processing ends.

Returning to FIG. 4 again, after the preliminary learning by the MLP decoder ends, the processing proceeds to step 403. In step 403, by using the learned VAE and MLP decoder, as the generation model, many pieces of generated defective product feature quantity data are generated.

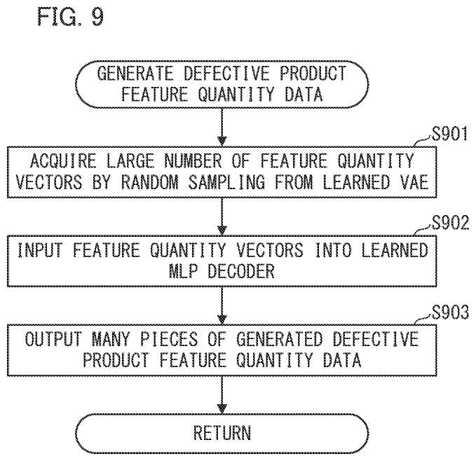

FIG. 9 illustrates details of the defective product feature quantity data generation processing. First, in step 901, M feature quantity vectors in k-dimension Vk are generated and acquired by random sampling from the latent variable in k-dimension and the latent probability distribution of the learned VAE. Next, in step 902, M feature quantity vectors in k-dimension Vk that have been acquired are input into the learned MLP decoder. Accordingly, in step 903, the MLP decoder outputs M pieces of generated defective product feature quantity data in p-dimension respectively corresponding to M feature quantity vectors in k-dimension Vk, and the present processing ends.

M pieces of generated defective product feature quantity data in p-dimension that have been generated in this manner are acquired as the defective product teacher data, and the defective product teacher data acquisition processing of FIG. 4 ends. In addition, by acquiring a sufficient number of pieces of non-defective product teacher data and defective product teacher data in this manner, the teacher data preparation processing of FIG. 1 ends.

Note that M pieces of non-defective product teacher data (non-defective product feature quantity data in p-dimension) and M pieces of defective product teacher data (defective product feature quantity data in p-dimension) are transmitted to the inspection device 3, and are used as the learning teacher data for the classification model in the inspection device 3. Then, the quality of the inspected object G is determined by the inspection device 3 including the classification model that has completed the learning.

As described heretofore, according to the present embodiment, regarding many (M) pieces of non-defective product image data that have been acquired, by extracting the non-defective product feature quantity data in p-dimension in accordance with a predetermined known algorithm, many (M) pieces of non-defective product teacher data are acquired. On the other hand, regarding a few (N) pieces of defective product image data that have been acquired, after the defective product feature quantity data in p-dimension is extracted in accordance with a predetermined known algorithm, the learning by the generation model is performed by use of the extracted data. Many (M) pieces of generated defective product feature quantity data in p-dimension are generated by the learned generation model, and many (M) pieces of defective product teacher data are acquired. Accordingly, as compared with the case where the pseudo defective product image is generated by the generation model, the number of parameters to be processed by the generation model can be greatly reduced, and the number of defective product images necessary for the learning of the generation model can be reduced. Therefore, it becomes possible to provide the teacher data preparation method capable of preparing teacher data with sufficient amount and quality, based on a large number of non-defective product images and a small number of defective product images.

More specifically, in the generation model in the present embodiment, it is sufficient if the MLP decoder decodes the generated defective product feature quantity data in p-dimension (for example, 1000 dimensions) from the feature quantity vectors in k-dimension (for example, 500 dimension). Therefore, the number of parameters in the decoder is significantly reduced, as compared with the decoder of the generation model that generates the pseudo defective product images. Therefore, it is possible to generate the generated defective product feature quantity data with sufficient quality, based on a small number of defective product images.

Note that the present invention is not limited to the above-described embodiments, and can be implemented in various modes. For example, in the embodiments described above, M pieces are set to both the number of pieces of non-defective product teacher data and the number of pieces of defective product teacher data for the sake of convenience. However, the number of pieces of non-defective product teacher data and the number of pieces of defective product teacher data are not necessarily the same, and can be set to different numbers as long as the learning of the classification model in the inspection device is not hindered.

In addition, in an embodiment, the latent variable of the VAE is set to k-dimension (for example, 500 dimensions), and the non-defective product feature quantity data and the defective product feature quantity data are set to p-dimension (for example, 1000 dimensions). However, “k<p” is not necessarily established. “k=p” or “k>p” may be established in accordance with a design of the teacher data preparation device or the classification model of the inspection device. Further, the detailed configuration of the teacher data preparation device 11 described in an embodiment is merely an example, and can be appropriately changed within the scope of the gist of the present invention.

What is claimed is:

1. A teacher data preparation method for preparing non-defective product teacher data and defective product teacher data, in a defect classification model that performs learning using a non-defective product image that is an image of a product or a component with no defect and a defective product image that is an image of a product or a component with a defect, the teacher data preparation method comprising:
a non-defective product teacher data acquiring step for acquiring, as the non-defective product teacher data, many pieces of non-defective product feature quantity data obtained by extracting a feature quantity in a predetermined first number of dimensions from a large number of the non-defective product images; and
a defective product teacher data acquiring step for acquiring, as the defective product teacher data, many pieces of generated defective product feature quantity data obtained by generating the feature quantity in the predetermined first number of dimensions, by using a generation model that has performed learning using defective product feature quantity data obtained by extracting the feature quantity in the predetermined first number of dimensions from the defective product images smaller in number than the non-defective product images.

2. The teacher data preparation method according to claim 1, wherein
the defective product teacher data acquiring step includes:
a first learning step for learning weighting of an encoder and a decoder to minimize a reconstruction error between an original image and a reconstructed image, in a variational auto encoder (VAE) including the encoder and the decoder, when the defective product image is input as the original image, the encoder reducing a dimension of the feature quantity that has been extracted from the original image and calculating a latent variable in a predetermined second number of dimensions and a probability distribution of the latent variable, the decoder reconstructing the original image from the latent variable and the probability distribution and outputting the reconstructed image;
a correct answer data acquiring step for extracting the feature quantity in the predetermined first number of dimensions from the defective product image to acquire as learning correct answer data;
a feature quantity vector acquiring step for acquiring a feature quantity vector in the predetermined second number of dimensions corresponding to the defective product image from the probability distribution of the latent variable of the VAE that has performed the learning;
a second learning step for learning weighting of a multilayer perceptron (MLP) decoder to minimize a loss between the generated defective product feature quantity data and the learning correct answer data, in the MLP decoder configured to generate and output the generated defective product feature quantity data in the predetermined first number of dimensions, when the feature quantity vector in the predetermined second number of dimensions that has been acquired is input; and
a defective product feature quantity data generating step for inputting a large number of feature quantity vectors in the predetermined second number of dimensions that have been acquired by random sampling from the probability distribution of the latent variable of the VAE that has performed the learning into the MLP decoder that has performed the learning to generate many pieces of generated defective product feature quantity data.

3. A teacher data preparation device that prepares non-defective product teacher data and defective product teacher data, in a defect classification model that performs learning using a non-defective product image that is an image of a product or a component with no defect and a defective product image that is an image of a product or a component with a defect, the teacher data preparation device comprising:
a non-defective product teacher data acquisition unit configured to acquire, as the non-defective product teacher data, many pieces of non-defective product feature quantity data obtained by extracting a feature quantity in a predetermined first number of dimensions from a large number of the non-defective product images; and
a defective product teacher data acquisition unit configured to acquire, as the defective product teacher data, many pieces of generated defective product feature quantity data obtained by generating the feature quantity in the predetermined first number of dimensions, by using a generation model that has performed learning using defective product feature quantity data obtained by extracting the feature quantity in the predetermined first number of dimensions from the defective product images smaller in number than the non-defective product images.

4. The teacher data preparation device according to claim 3, wherein the defective product teacher data acquisition unit includes:
a first learning unit configured to learn weighting of an encoder and a decoder to minimize a reconstruction error between an original image and a reconstructed image, in a variational auto encoder (VAE) including the encoder and the decoder, when the defective product image is input as the original image, the encoder reducing a dimension of the feature quantity that has been extracted from the original image and calculating a latent variable in a predetermined second number of dimensions and a probability distribution of the latent variable, the decoder reconstructing the original image from the latent variable and the probability distribution and outputting the reconstructed image;
a correct answer data acquisition unit configured to extract the feature quantity in the predetermined first number of dimensions from the defective product image to acquire as learning correct answer data;
a feature quantity vector acquisition unit configured to acquire a feature quantity vector in the predetermined second number of dimensions corresponding to the defective product image from the probability distribution of the latent variable of the VAE that has performed the learning;
a second learning unit configured to learn weighting of a multilayer perceptron (MLP) decoder to minimize a loss between the generated defective product feature quantity data and the learning correct answer data, in the MLP decoder configured to generate and output the generated defective product feature quantity data in the predetermined first number of dimensions, when the feature quantity vector in the predetermined second number of dimensions that has been acquired is input; and
a defective product feature quantity data generation unit configured to input a large number of feature quantity vectors in the predetermined second number of dimensions that have been acquired by random sampling from the probability distribution of the latent variable of the VAE that has performed the learning into the MLP decoder that has performed the learning to generate many pieces of generated defective product feature quantity data.
